(19) United States
(12) Patent Application Publication
(10) Pub. No.: US 2008/0084288 A1
(43) Pub. Date: Apr. 10, 2008

(54) Method Of Monitoring Tire Pressure In A Motor Vehicle

(75) Inventors: Helmut Fennel, Bad Soden (DE); Vladimir Koukes, Darmstadt (DE); Martin Griesser, Eschborn (DE); Peter Sager, Friedrichsdorf (DE)

Correspondence Address: Gerlinde Nattler;Continental Teves, Inc., One Continental Drive, Auburn Hills, MI, 48326, US

(73) Assignee: Continental Teves AG & Co. oHG

(21) Appl. No.: 11/664,669

(22) PCT Filed: Oct. 5, 2005
(86) PCT No.: PCT/EP05/54999

§ 371 Date: Oct. 5, 2007

(30) Foreign Application Priority Data
Oct. 5, 2004 (DE) 10 2004 049 013.9
Sep. 2, 2005 (DE) 10 2005 042 061.3

(51) Int. Cl. B60C 23/04; B60C 23/02

(52) U.S. Cl. 340/442

(57) ABSTRACT

A method of monitoring tire pressure in a motor vehicle employs an indirectly measuring tire pressure monitoring system (DDS) and a directly measuring tire pressure monitoring system (TPMS) with two pressure sensors for determining tire pressure and/or tire pressure loss. Depending on the arrangement (axlewise, sidewise or diagonal) of the pressure sensors at the vehicle wheels, a reference value (DIAG, SIDE, AXLE) of the indirectly measuring tire pressure monitoring system (DDS) is used as the main reference value for detecting tire inflation pressure loss.

### BACKGROUND OF THE INVENTION

The present invention relates to a method of monitoring tire pressure in a motor vehicle employing an indirectly measuring tire pressure monitoring system (DDS) and a directly measuring tire pressure monitoring system (TPMS) with two pressure sensors for determining tire pressure and/or tire pressure loss.

It is of great significance for vehicle safety to reliably monitor the tire pressure on all wheels of a motor vehicle. There are different approaches how to realize tire pressure monitoring systems. So-called tire pressure monitoring systems with direct pressure measurement exist, as described in application DE 199 26 616 C2, which determine the respective pressure in the associated wheel by means of pressure sensors in the individual tires. Systems of this type monitor the tire pressure on all wheels independently, yet they are relatively expensive as they require additional devices, e.g. for transmitting and evaluating the pressure sensor information.

Further, so-called indirectly measuring tire pressure monitoring systems are known, e.g. from DE 100 58 140 A1, which can detect pressure loss based on auxiliary quantities, e.g. by comparing the rolling circumferences of the individual wheels. Admittedly, systems of this type are inexpensive and reliable, yet they do not function if pressure loss is encountered on all four wheels.

In addition, DE 100 60 392 A1 discloses a tire pressure monitoring device, which comprises a combination of a tire pressure monitoring system with indirect measurement and a tire pressure monitoring system with direct measurement. The task of the tire pressure monitoring device described in this publication is to detect inflation pressure loss on all four wheels by means of the combination of a tire pressure sensor and the tire pressure monitoring system with indirect measurement. It is disadvantageous in this respect that when using only one tire pressure sensor, the wheels on which no tire pressure sensors are mounted can only be monitored with relatively high detection thresholds. The consequence is that inflation pressure loss is detected at a very late point of time only. It is achieved by the alternative use of two tire pressure sensors as mentioned in the above publication, with exactly one tire pressure sensor being arranged on each vehicle axle, that individual tire pressure nominal values can be determined for each axle. However, this provision does not lead to a considerably earlier detection of inflation pressure loss. As a tire pressure monitoring system with indirect measurement operates on the basis of rotational wheel speeds and, hence, is directly dependent on the wheel rolling circumference, frequently pressure loss on the driven wheels can be detected only very insufficiently or in rare moments of their free rolling.

In view of the above, an object of the invention is to provide an improved method for tire pressure monitoring in a motor vehicle, which includes an indirectly measuring tire pressure monitoring system (DDS) and a directly measuring tire pressure monitoring system (TPMS) with only two pressure sensors.

### SUMMARY OF THE INVENTION

This object is achieved by the method according to the invention, wherein, depending on the arrangement (axlewise, side-wise or diagonal) of the pressure sensors at the vehicle wheels, a reference value (DIAG, SIDE, AXLE) of the indirectly measuring tire pressure monitoring system (DDS) is used as the main reference value for detecting tire inflation pressure loss.

One advantage of the invention involves that the method for tire pressure monitoring is functioning for any desired arrangement of the pressure sensors on the vehicle wheels. It is important to this end that the reference values of the indirectly measuring tire pressure monitoring system and the model for the dependency of the reference values on the tire pressures are connected to each other in such a way that the calculations for detecting the pressure losses have a high rate of precision. Only this way is it possible to detect pressure losses at an early point of time, especially stealthy pressure losses on several wheels.

In a preferred embodiment of the method of the invention, three reference values (DIAG, SIDE and AXLE) are produced from the wheel revolution times of the individual wheels.

Favorably, three compensated reference values ΔD_{DIAGcomp}, ΔD_{SIDEcomp} and ΔD_{AXLEcomp} are produced from the three reference values (DIAG, SIDE and AXLE) and the directly measured pressure values in order to detect tire pressure loss.

The invention is described by making reference to one embodiment.

### DETAILED DESCRIPTION OF A PREFERRED EMBODIMENT

The indirectly measuring tire pressure monitoring system (DDS) detects tire pressure loss by way of a variation of the rolling circumferences or the wheel speeds of the vehicle wheels, respectively, the wheel speeds being measured by means of wheel rotational speed sensors. This indirectly measuring tire pressure monitoring system (DDS) is combined with a directly measuring tire pressure monitoring system (TPMS), which includes only two pressure sensors. This combination renders it possible to reliably monitor all vehicle tires with respect to tire pressure loss, without using a complete directly measuring tire-pressure monitoring system, i.e. equipped with four pressure sensors.

The indirectly measuring tire pressure monitoring system (DDS) normally employs for a tire pressure check non-dimensional reference values, which are determined from the wheel rotational speeds. The wheel rotational speeds n depend on the tire rolling circumferences Aⱼ (j=1, 2, 3, 4) and on the vehicle speed V:

$$n = \frac{V}{{A}_{j}} \qquad ( 1 )$$

Any reference value Dᵢ desired can therefore be expressed as a function F of the tire rolling circumferences Aⱼ (j=1, 2, 3, 4).

Dᵢ=F(A₁, A₂, A₃, A₄) (2)

i=1, 2, 3

As the rolling circumferences Aⱼ (j=1, 2, 3, 4) depend on the tire pressures P, and hence also on the variations of the tire pressures ΔPⱼ (j=1, 2, 3, 4), the optional reference value Dᵢ can also be written as function Φ of the variations of the tire pressures ΔPⱼ (j=1, 2, 3, 4).

Dᵢ=Φ(ΔP₁, ΔP₂, ΔP₃, ΔP₄) (3)

i=1, 2, 3

Because it is not possible to obtain more than three independent non-dimensional values from four wheel rotational speeds, only three equations are available for the four unknown tire rolling circumferences or pressure variations, respectively, out of the indirectly measuring tire pressure monitoring system (DDS). Therefore, two pressure sensors of a directly measuring tire pressure monitoring system (TPMS) are evaluated in addition in order to reliably detect inflation pressure loss. These two pressure sensors may be arranged at any location in or at the vehicle tires. Thus, the pressure sensors can be disposed in each case at the two wheels of one axle (axlewise arrangement) or at respectively one wheel of the front axle and one wheel of the rear axle. In this respect, the pressure sensors can be arranged at the left or the right vehicle side (sidewise arrangement) or diagonally (diagonal arrangement) at the vehicle, e.g. one pressure sensor at the left front wheel and one pressure at the right rear wheel.

The rolling circumference A of the tire in a first approximation depends on the sum of the basic rolling circumference

A₀ of the tire and the product of a proportionality coefficient k and the tire pressure P. The basic rolling circumference A₀ describes the rolling circumference at a tire pressure of P=0.

A≈A₀+k·P (4)

The relative variation of the rolling circumference ΔA/A thus depends linearly on the relative variation of the pressure ΔP/P:

ΔA/A≈k·ΔP/P (5)

The variations of the three reference values ΔDᵢ (i=1, 2, 3) depend on the pressures of all four wheels δPⱼ=ΔPⱼ/Pⱼ(j=1, 2, 3, 4):

ΔDᵢ=f(δP₁, δP₂, δP₃, δP₄)≈f₁(δP₁)+f₂(δP₂)+f₃(δP₃)+f₄(δP₄) (6)

The functions f₁ to f₄ are also linear in a first approximation, therefore, it is possible to use three linear equations for the calculation of the pressure variations:

$$Δ {D}_{i} \approx {k}_{i 1} \cdot δ {P}_{1} + {k}_{i 2} \cdot δ {P}_{2} + {k}_{i 3} \cdot δ {P}_{3} + {k}_{i 4} \cdot δ {P}_{4} = {\sum }_{j = 1}^{4} {k}_{ij} \cdot δ {P}_{j} \\ i = 1 , 2 , 3 \qquad ( 7 )$$

The coefficients kᵢ₁ to kᵢ₄ depend on the properties of the tires and must be determined empirically. When the tire pressure in a wheel has been measured directly, this tire pressure can be considered a known quantity in the three equations 7. In this case, the three linear equations 7 form a defined system, what means that the pressure variations on all wheels can be determined (checked).

When a tire pressure check system M (M≧1) includes directly measuring pressure sensors, the system can be outlined according to the equations 7 as follows:

$$Δ {D}_{icomp} = Δ {D}_{i} - {\sum }_{j = 1}^{M} {k}_{ij} \cdot δ {P}_{j} = {\sum }_{j = 1}^{4 - M} {k}_{ij} \cdot δ {P}_{j} \\ i = 1 , 2 , 3 \qquad ( 8 )$$

Each compensated reference value ΔD_{icomp} according to equation 8 depends on (4−M)-tire pressures in the tires without pressure sensors. In order to calculate the tire pressures, only (4−M)-equations can be used by the system according to equation 8. These equations must be linearly independent.

When the directly measuring tire pressure monitoring system (TPMS) includes two pressure sensors, the following arrangements of the two pressure sensors at the vehicle or at the vehicle wheels are possible:

pressure sensors in a diagonal arrangement

pressure sensors in an axlewise arrangement

pressure sensors in a sidewise arrangement

For each of the above-mentioned positions of the pressure sensors, one of the three reference values (DIAG, SIDE, AXLE) is chosen as a main reference value for the monitoring operation. In this case, the reference values (DIAG, SIDE, AXLE) are basically composed of the wheel revolution times T of the individual wheels. The wheel revolution times T are determined from the wheel rotational speeds n of the wheels.

In case that the pressure sensors are arranged on the vehicle diagonal, the reference value DIAG is used as the main reference value:

$$DIAG = \frac{{T}_{FL} + {T}_{RR}}{{T}_{FR} + {T}_{RL}} - 1 \\ T = \frac{1}{n} \qquad ( 9 )$$

The indices FL, FR, RL, RR refer to the front left (FL), front right (FR), rear left (RL) and rear right (RR) wheels.

In case that the pressure sensors are arranged on one vehicle side, the reference value SIDE is used as the main reference value:

$$SIDE = \frac{{T}_{FL} + {T}_{RL}}{{T}_{FR} + {T}_{RR}} - 1 \qquad ( 10 )$$

In case that the pressure sensors are arranged on one vehicle axle, the reference value AXLE is used as the main reference value:

$$AXLE = \frac{{T}_{FL} + {T}_{FR}}{{T}_{RL} + {T}_{RR}} - 1 \qquad ( 11 )$$

To detect tire pressure loss, three compensated reference values ΔD_{DIAGcomp}, ΔD_{SIDEcomp} and ΔD_{AXLEcomp} with ΔD_{DIAG}=DIAG, ΔD_{SIDE}=SIDE AND ΔD_{AXLE}=AXLE are produced from the equations 9 to 11 by using equation 8. It further applies in the directly measuring tire pressure monitoring system (TPMS) with two pressure sensors that M=2.

A warning with regard to tire pressure loss must be given, for example, when one or several pressure reductions δPⱼ exceed a defined threshold (e.g. 25%).

For the reference value (DIAG, SIDE, AXLE) used as the main reference value, two different threshold values (low threshold value, high threshold value) are defined for the detection of tire pressure loss. These threshold values are determined empirically. In this arrangement, the high threshold value is e.g. twice as high as the low threshold value. When the result of the analysis of all three compensated reference values (ΔD_{DIAGcomp}, ΔD_{SIDEcomp} and ΔD_{AXLEcomp}) is that pressure loss occurs in one vehicle tire, a warning with regard to tire pressure loss is given when the main reference value (DIAG, SIDE or AXLE) exceeds the low threshold value for this main reference value. If the analysis shows that pressure loss occurs in two vehicle tires without pressure sensors, then a warning with regard to tire pressure loss is given when the main reference value exceeds the high threshold value. When pressure loss is detected by a pressure sensor at a wheel, the warning with regard to tire pressure loss is given when a defined threshold (e.g. pressure loss is higher than 25%) is exceeded. This pressure loss can also be tested by the above method in order to preclude a defect of a pressure sensor, for example.

A simplified linear model is used to detect the tire pressure variations of the system according to equation 8.

1.-9. (canceled)

10. A method of monitoring tire pressure in a motor vehicle employing an indirectly measuring tire pressure monitoring system (DDS) and a directly measuring tire pressure monitoring system (TPMS) with two pressure sensors for determining tire pressure and tire pressure loss, comprising the steps of
generating a reference value (DIAG, SIDE, AXLE) of the indirectly measuring tire pressure monitoring system (DDS) depending on the arrangement (axlewise, sidewise or diagonal) of the pressure sensors at the vehicle wheels,
detecting tire inflation pressure loss using the reference value as a main reference value, and
generating warning in case of a tire inflation loss.

11. The method as claimed in claim 10,
wherein the reference value DIAG is used as the main reference value when each one pressure sensor is arranged at the left front wheel (FL) and the right rear wheel (RR), or at the right front wheel (RF) and the left rear wheel (LR), wherein
$$DIAG = \frac{{T}_{FL} + {T}_{RR}}{{T}_{FR} + {T}_{RL}} - 1 , \\ T = \frac{1}{n} ,$$
and n is the rotational wheel speed.

12. The method as claimed in claim 10,
wherein the reference value SIDE is used as the main reference value when each one pressure sensor is arranged at the left front wheel (FL) and the left rear wheel (RL), or at the right front wheel (FR) and the right rear wheel (RR), wherein
$$SIDE = \frac{{T}_{FL} + {T}_{RL}}{{T}_{FR} + {T}_{RR}} - 1 , \\ T = \frac{1}{n} ,$$
and n is the rotational wheel speed.

13. The method as claimed in claim 10,
wherein the reference value AXLE is used as the main reference value when each one pressure sensor is arranged at the left front wheel (FL) and the right front wheel (FR), or at the right rear wheel (RR) and the left rear wheel (RL), wherein
$$AXLE = \frac{{T}_{FL} + {T}_{FR}}{{T}_{RL} + {T}_{RR}} - 1 , \\ T = \frac{1}{n} ,$$
and n is the rotational wheel speed.

14. The method as claimed in claim 10,
wherein two differently high, empirically determined threshold values (low threshold value, high threshold value) are used for the reference value in order to detect tire pressure loss.

15. The method as claimed in claim 14 for a vehicle with four tire pressure sensors,
wherein three reference values (DIAG, SIDE, AXLE) are calculated with different pairs of tire pressure sensors, comprising the step of
generating a compensated reference value (ΔD_{DIAGcomp}, ΔD_{SIDEcomp} and ΔD_{AXLEcomp}) from each reference value (DIAG, SIDE, AXLE) to detect a tire pressure loss, the compensated value being obtained in each case by means of a linear function.

16. The method as claimed in claim 15,
wherein a tire inflation pressure loss is detected when all three compensated reference values (ΔD_{DIAGcomp}, ΔD_{SIDEcomp} and ΔD_{AXLEcomp}) identify a vehicle tire as the tire with pressure loss, and when the main reference value exceeds the high threshold value.

17. The method as claimed in claim 14,
wherein tire pressure loss at two vehicle tires without pressure sensors is detected when the main reference value exceeds the high threshold value.
